(19) United States
(12) Patent Application Publication
(10) Pub. No.: US 2026/0038290 A1
(43) Pub. Date: Feb. 5, 2026

(54) AUTOMATICALLY DETECTING AND RESOLVING VISUAL MISINTERPRETATIONS OF SCANNED IMAGES BY A COMPUTER

(71) Applicant: Truist Bank, Charlotte, NC (US)

(72) Inventors: Veeranjaneya Chandu, Charlotte, NC (US); Tiffany McKinney, Charlotte, NC (US); Louis Allin, Charlotte, NC (US); Priya Kenkare Shankaranarayana, Charlotte, NC (US); Ramya Kolla, Charlotte, NC (US); Jonathan Topp, Charlotte, NC (US); Omganesh Teekaramsingh, Charlotte, NC (US)

(73) Assignee: Truist Bank, Charlotte, NC (US)

(21) Appl. No.: 18/795,456

(22) Filed: Aug. 6, 2024

Related U.S. Application Data
(63) Continuation of application No. 18/792,728, filed on Aug. 2, 2024.

(51) Int. Cl. G06V 30/12; G06V 30/146; G06V 30/148; G06V 30/19; G06V 30/244; G06V 30/40

(52) U.S. Cl. CPC G06V 30/12; G06V 30/1475; G06V 30/148; G06V 30/19; G06V 30/245; G06V 30/40

(57) ABSTRACT

In some examples, a system can use machine learning to automatically detect and resolve a visual misinterpretation of a scanned image generated by an automated character recognition (ACR) algorithm. For example, the system can execute a machine-learning model on interaction data extracted from an image of a physical document for initiating an interaction between entities. The interaction data can include a discrepancy such that the interaction data is different from one or more expected values. The machine-learning model can determine whether the discrepancy was caused by a visual misinterpretation of the image when the ACR algorithm was applied to the image to extract the interaction data. In response to determining that the discrepancy was caused by the visual misinterpretation, the machine-learning model can apply an adjustment to the interaction data to resolve the visual misinterpretation. Applying the adjustment can generate updated interaction data usable to initiate the interaction.

### CROSS-REFERENCE TO RELATED APPLICATIONS

This application is a continuation of U.S. patent application Ser. No. 18/792,728, filed Aug. 2, 2024, titled “AUTOMATICALLY DETECTING AND RESOLVING VISUAL MISINTERPRETATIONS OF SCANNED IMAGES BY A COMPUTER, the entirety of which is incorporated herein by reference.

### TECHNICAL FIELD

The present disclosure relates generally to automated analysis of scanned images. More specifically, but not by way of limitation, this disclosure relates to automatically detecting and resolving visual misinterpretations of scanned images by a computer.

### BACKGROUND

A user can initiate an interaction with an entity via a digital interaction channel or a non-digital interaction channel. In some cases, the interaction may involve a transfer of resources. An entity server associated with the entity can validate and process the interaction using interaction data provided by the user. In some cases, validating the interaction can involve a manual review of the interaction data that can be inefficient in terms of man-hours. If the interaction is deemed invalid or unverified based on the interaction data, the interaction may be flagged to prevent unauthorized modifications to the resources.

### SUMMARY

In some examples, a system includes a processing device and a memory device that includes instructions executable by the processing device for causing the processing device to perform operations. The operations include executing a machine-learning model on interaction data extracted from an image of a physical document. The physical document can be for initiating an interaction between two entities. The interaction data can include a discrepancy such that the interaction data is different from one or more expected values. The machine-learning model can determine whether the discrepancy was caused by a visual misinterpretation of the image when an automated character recognition algorithm was applied to the image to extract the interaction data. The operations additionally include, in response to determining that the discrepancy was caused by the visual misinterpretation of the image, applying, by the machine-learning model, an adjustment to the interaction data to resolve the visual misinterpretation. Applying the adjustment can generate updated interaction data usable to initiate the interaction.

In some examples, a method involves executing a machine-learning model on interaction data extracted from an image of a physical document. The physical document can be for initiating an interaction between two entities. The interaction data can include a discrepancy such that the interaction data is different from one or more expected values. The machine-learning model can determine whether the discrepancy was caused by a visual misinterpretation of the image when an automated character recognition algorithm was applied to the image to extract the interaction data. The method additionally involves, in response to determining that the discrepancy was caused by the visual misinterpretation of the image, applying, by the machine-learning model, an adjustment to the interaction data to resolve the visual misinterpretation. Applying the adjustment can generate updated interaction data usable to initiate the interaction.

In some examples, a non-transitory computer-readable medium includes program code executable by a processing device for causing the processing device to perform operations. The operations include executing a machine-learning model on interaction data extracted from an image of a physical document. The physical document can be for initiating an interaction between two entities. The interaction data can include a discrepancy such that the interaction data is different from one or more expected values. The machine-learning model can determine whether the discrepancy was caused by a visual misinterpretation of the image when an automated character recognition algorithm was applied to extract the interaction data from the image. The operations additionally include, in response to determining that the discrepancy was caused by the visual misinterpretation of the image, applying, by the machine-learning model, an adjustment to the interaction data to resolve the visual misinterpretation. Applying the adjustment can generate updated interaction data usable to initiate the interaction.

### BRIEF DESCRIPTION OF THE DRAWINGS

FIG. 1 is a block diagram of an example of a computing environment for automatically detecting and resolving a visual misinterpretation of a scanned image according to some aspects of the present disclosure.

FIG. 2 is a block diagram of an example of a sequence for automatically detecting and resolving a visual misinterpretation arising from an automated character recognition (ACR) algorithm misrecognizing a first alphanumeric character as a second alphanumeric character according to some aspects of the present disclosure.

FIG. 3 is a block diagram of an example of a sequence for automatically detecting and resolving a visual misinterpretation arising from an ACR algorithm adding an extraneous character according to some aspects of the present disclosure.

FIG. 4 is a block diagram of an example of a sequence for automatically detecting and resolving a visual misinterpretation arising from an ACR algorithm omitting a whitespace according to some aspects of the present disclosure.

FIG. 5 is a block diagram of an example of a sequence for automatically detecting and resolving a visual misinterpretation arising from an image being askew relative to an expected orientation according to some aspects of the present disclosure.

FIG. 6 is a block diagram of an example of a computing system usable for automatically detecting and resolving a visual misinterpretation of a scanned image according to some aspects of the present disclosure.

FIG. 7 is a flowchart of a process for automatically detecting and resolving a visual misinterpretation of a scanned image according to some aspects of the present disclosure.

### DETAILED DESCRIPTION

Certain aspects of the present disclosure relate to automatically detecting and resolving a visual misinterpretation of a scanned image by a computer. The techniques described herein can be applied in the context of a computing system that uses an automated character recognition (ACR) algorithm to extract interaction data from text provided in the scanned image of a physical document. The computing system can compare the interaction data obtained from the scanned image to one or more expected values. If the interaction data is inconsistent with the expected values, the computing system may determine that the interaction associated with the interaction data is unauthorized. So, the computing system may prevent the interaction from succeeding. Otherwise, the computer system may allow the interaction to proceed.

In the above context, there are certain situations in which a discrepancy between the interaction data and the expected data is not the result of malicious activity, but rather an error in the ACR process. Using the ACR algorithm to convert typed, handwritten, or printed text provided in the image into machine-readable text can facilitate data entry but may also result in the typographical errors in the machine-readable text. The typographical errors can cause erroneous detection of discrepancies between the machine-readable text and the expected values. Accuracy of the ACR algorithm can vary based on one or more factors, such as a typeface used on the imaged document, readability of the image, the angle of the document in the scanned image, or whether the text is handwritten. For instance, the ACR algorithm may confuse ‘0’ with ‘O’, whereas a person can distinguish between these characters, such as by using context of adjacent text provided in the scanned image. As another example, the ACR algorithm may be applicable for a limited number of typefaces such that applying the ACR algorithm to convert other typefaces may result in typographical errors or other errors related to low detection accuracy. In conventional systems, these ACR errors can have negative impacts on downstream processes that rely on the output of the ACR algorithm, which may require human intervention to correct. For example, the interaction data may include one or more typographical errors introduced by the ACR algorithm due to the visual misinterpretation of the scanned image. The typographical errors can cause the discrepancy in the interaction data, resulting in an erroneous (e.g., false positive) identification of the interaction as unauthorized.

Some examples of the present disclosure can overcome the abovementioned problem by reducing or mitigating errors introduced by the ACR algorithm. For example, the computing system can use machine learning to determine that a discrepancy was caused by the visual misinterpretation of the scanned image rather than image manipulation. The computing system then can generate updated interaction data by applying an adjustment to the interaction data to update the interaction data and resolve the visual misinterpretation. The updated interaction data can be used to initiate an interaction associated with the interaction data.

The computing system can use a machine-learning model or other techniques to identify and resolve discrepancies in the interaction data that are caused by the visual misinterpretation of the text in the scanned image. For instance, the machine-learning model can be trained to determine a reason for a discrepancy between the interaction data and the expected values, such as that the discrepancy is due to the visual misinterpretation by the ACR algorithm rather than an unauthorized interaction. For instance, training the machine-learning model can involve developing pattern recognition to identify that the visual misinterpretation was caused by a readability obstruction (e.g., smudges, alignment issues, etc.) associated with the image. Once the visual misinterpretation is detected, the machine-learning model can determine an adjustment to the interaction data or the scanned image based on the visual misinterpretation. The adjustment can be configured to resolve the discrepancy. For example, the machine-learning model can improve an accuracy of the ACR algorithm by removing spots (e.g., outlier pixels) from the scanned image or tilting the scanned image to enhance readability of the scanned image. In some implementations, the adjustment may be applied to the interaction data. Additionally or alternatively, the adjustment can be applied to the scanned image to modify the scanned image. Modifying the scanned image may improve readability of the image for the ACR algorithm during a subsequent pass (e.g., another ACR of the modified scanned image).

In some examples, if the adjustment is applied to the scanned image to generate an updated image, the computing system may execute the ACR algorithm again on the updated image to obtain updated interaction data from the updated image. In other examples, the computing system can apply the adjustment to the interaction data to generate the updated interaction data. The computing system then can compare the updated interaction data with the expected values to determine whether the discrepancy is still present. In some cases, if the computing system determines that the discrepancy is absent from the updated interaction data, the computing system can use the updated interaction data to initiate the interaction associated with the interaction data. For instance, the computing system can initiate a resource transfer between two entities as the interaction using the updated interaction data that can include a recipient of resources, a provider of the resources, and an amount of the resources. In alternative cases, the computing system may determine that at least one additional discrepancy is present in the updated interaction data. Accordingly, the computing system can execute the machine-learning model to address the additional discrepancy. The computing system may repeat this process of identifying and resolving discrepancies of the interaction data until new interaction data generated by the ACR algorithm is free from any discrepancies.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

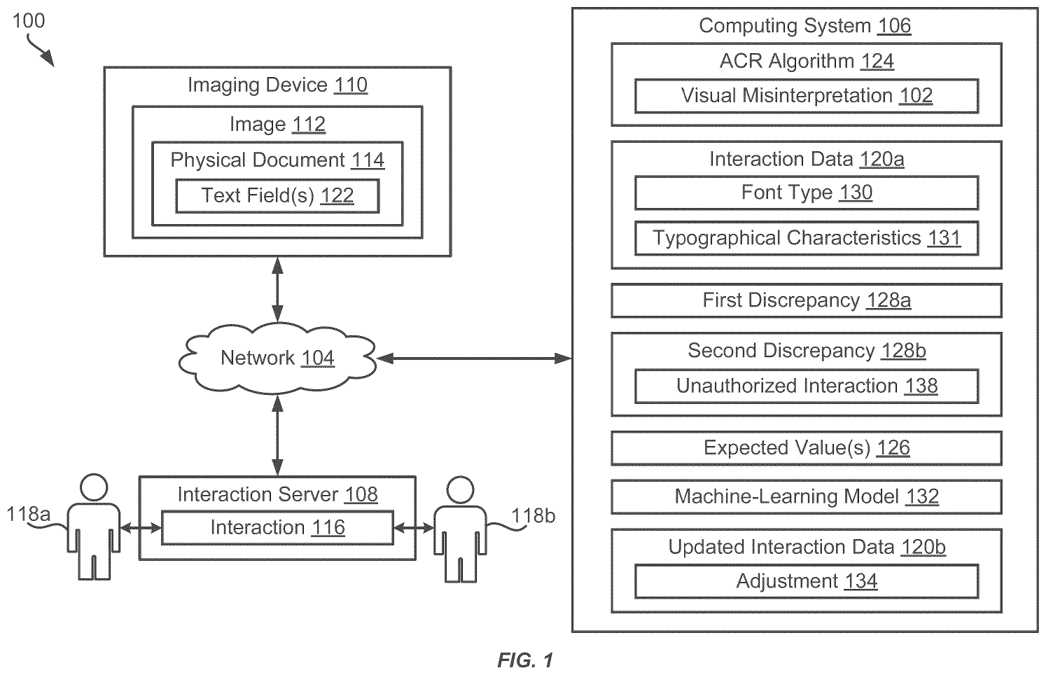

FIG. 1 is a block diagram of an example of a computing environment 100 for automatically detecting and resolving a visual misinterpretation 102 of a scanned image 112 according to some aspects of the present disclosure. Components within the computing environment 100 may be communicatively coupled via a wireless connection (e.g., a network 104, IEEE 802.11, Bluetooth, or radio interfaces for accessing cellular telephone networks). Examples of the network 104 can include a local area network (LAN), wide area network (WAN), the Internet, or a combination of these. For example, the computing environment 100 can include a computing system 106 and an interaction server 108 that are communicatively coupled via the network 104. Examples of the computing system 106 can include a desktop computer, laptop computer, server, mobile phone, or tablet. In some examples, the computing environment 100 additionally can include an imaging device 110 communicatively coupled to the computing system 106, for example via the network 104 as depicted in FIG. 1. As another example, the imaging device 110 can be communicatively coupled to the computing system 106 via a wired connection (e.g., Ethernet, universal serial bus (USB), IEEE 1394, or a fiber optic interface).

The imaging device 110 can be used to generate the image 112 of a physical document 114 that can be analyzed by the computing system 106. For example, the imaging device 110 can include a camera or scanner that can image the physical document 114 to generate a digital version of the physical document as the image 112. The physical document 114 can be used to initiate an interaction 116 (e.g., a resource transfer) between two entities 118a-b. In some instances, a first entity 118a may provide interaction data 120a associated with the interaction 116 via the physical document 114. The first entity 118a can use the physical document 114 to provide information associated with a second entity 118b to transfer an amount of resources from the first entity 118a to the second entity 118b. In some cases, the physical document 114 (e.g., a check) can be provided from the first entity 118a to the second entity 118b such that the second entity 118b can use the physical document 114 to initiate the interaction 116. For instance, the second entity 118b may use the imaging device 110 to generate the image 112 of the physical document 114, after the second entity 118b receives the physical document 114 from the first entity 118a. As another example, the first entity 118a may use the physical document 114 to request the amount of resources from the second entity 118b. The physical document 114 can include one or more text fields 122 that can provide the interaction data 120a associated with the interaction 116. The interaction data 120a provided in the text fields 122 may be typed text, handwritten text, or printed text.

The computing system 106 can obtain the interaction data 120a from the text fields 122 of the physical document 114 depicted in the image 112 using an automated character recognition (ACR) algorithm 124. For example, the computing system 106 may use an optical character recognition (OCR) algorithm as the ACR algorithm 124. Additionally or alternatively, the ACR algorithm 124 may implement other automated character recognition techniques, such as magnetic ink character recognition (MICR) or optical mark recognition. The ACR algorithm 124 can analyze the image 112 to classify a lighter portion of the image 112 as background and a darker portion of the image 112 as text. In some cases, the ACR algorithm 124 may apply preprocessing techniques (e.g., despeckling, deskewing, etc.) to the image 112 prepare the image 112 for character recognition analysis. Extracting the interaction data 120a from the text fields 122 provided in the image 112 can involve text recognition.

In some implementations, the ACR algorithm 124 may use pattern matching to recognize the interaction data 120a. For example, the ACR algorithm 124 can isolate a glyph (e.g., a character) in the text fields 122 and compare the glyph to one or more stored glyphs in a recognition database accessible by the ACR algorithm 124. Isolating the glyph can involve the ACR algorithm 124 performing segmentation with respect to the text fields 122 to separate the text fields 122 into separate words (e.g., a sequence of glyphs that lacks whitespaces) or lines (e.g., a string of contiguous words). Once the glyph is isolated, the ACR algorithm 124 can identify the glyph by determining a match between the glyph and a stored glyph in the recognition database. Additionally or alternatively, the ACR algorithm 124 can implement feature extraction to obtain the interaction data 120a from the text fields 122. For example, the ACR algorithm 124 can separate the glyph into one or more features (e.g., lines, closed loops, intersections, etc.) based on pixels of the glyph in the image 112. The ACR algorithm 124 then can use the features of the glyph to determine a closest match (e.g., using a nearest neighbor search or another suitable proximity search) of the stored glyphs in the recognition database.

In some cases, using the ACR algorithm 124 can involve applying machine learning to extract the interaction data 120a from the text fields 122 provided in the image 112. For example, intelligent character recognition (ICR) is a type of automated character recognition that can be used to extract handwritten text from the image 112. Using ICR to extract the interaction data 120a from the text fields 122 can involve implementing a neural network that can be trained to use a recognition database of handwriting patterns to recognize and extract text having different handwriting styles or fonts.

Once the computing system 106 obtains the interaction data 120a from the image 112, the computing system 106 can use the interaction data 120a to verify the interaction 116 associated with the interaction data 120a. The computing system 106 may compare the interaction data 120a to one or more expected values 126. In some examples, by comparing the interaction data 120a to the expected values 126, the computing system 106 can determine whether there is a discrepancy 128 between the interaction data 120a and the expected values 126. If the computing system 106 determines that the interaction data 120a differs from the expected values 126, the computing system 106 can use the expected values 126 as a baseline to determine an adjustment 134 to apply to the interaction data 120a. The adjustment 134 can correct the interaction data 120a to match or be consistent with the expected values 126.

Additionally or alternatively, the computing system 106 can compare the interaction data 120a and the expected values 126 by providing the interaction data 120a and the expected values 126 as input to a machine-learning model 132. Examples of the machine-learning model 132 can include a neural network, a support vector machine, a decision tree, or an ensemble of models. After receiving the input, the machine-learning model 132 can first compare the interaction data 120a and the expected values 126 to determine whether a discrepancy 128 between the interaction data 120a and the expected values 126 is present. In some cases, if the machine-learning model 132 determines that the discrepancy 128 is present, the machine-learning model 132 can analyze the interaction data 120a with respect to the discrepancy 128. In particular, the machine-learning model 132 can analyze the interaction data 120a to determine whether the discrepancy 128 was caused by the visual misinterpretation 102 of the image 112. Subsequently, the machine-learning model 132 can generate an output to indicating whether the discrepancy 128 was caused by the visual misinterpretation 102 of the image 112.

The expected values 126 can be provided in an internal database (e.g., part of the interaction server 108) accessible by the computing system 106. For instance, the first entity 118a may transmit the expected values 126 to the computing system 106, which can store the expected values 126 in the database for use in this comparison process. By comparing the interaction data 120a to the expected values 126, the computing system 106 can determine whether the discrepancy 128 is present in the interaction data 120a. The discrepancy 128 can correspond to a mismatch between the interaction data 120a and the expected values 126. In some cases, if the interaction data 120a matches the expected values 126, the computing system 106 can use the interaction data 120a to initiate the interaction 116. Once the interaction 116 is initiated, the computing system 106 can forward the interaction 116 for processing by the interaction server 108.

In other cases, the interaction data 120a may include a first discrepancy 128a, for example caused by a visual misinterpretation 102 of the image 112 by the ACR algorithm 124. In some examples, the visual misinterpretation 102 can result from the interaction data 120a including a font type 130 that may be difficult for the ACR algorithm 124 to analyze. For example, the font type 130 may include conjoined glyphs that can impede segmentation used by the ACR algorithm 124 to identify separate glyphs. As another example, the font type 130 may include one or more glyphs that vary in size or uniformity, causing issues with pattern recognition used by the ACR algorithm 124 to identify the glyphs. The computing system 106 can identify the font type 130 associated with the interaction data 120a, for example using a machine-learning model 132 trained to perform computer vision tasks.

In some examples, the computing system 106 can provide the interaction data 120a as input to the machine-learning model 132 to determine the font type 130 of the interaction data 120a. For example, the machine-learning model 132 can identify a respective width of glyphs (e.g., characters) associated with the font type 130. In such examples, the font type 130 may correspond to whether a particular font of the interaction data 120a is part of a proportional typeface containing glyphs of varying widths or a monospaced typeface having a standard width for all glyphs. In additional or alternative examples, the interaction data 120a may include more than one font type 130 (e.g., a mix of typed text and handwritten text). In some examples in which the interaction data 120a includes a mix of typed text and handwritten text, the machine-learning model 132 can separately determine the font type 130 for the typed text and the handwritten text. In particular, the machine-learning model 132 can identify a standardized font type for the typed text and can classify the font type 130 of the handwritten text using one or more labels (e.g., cursive, print, etc.). For example, the machine-learning model 132 may label handwritten text that is slanted and conjoined as cursive.

The computing system 106 then can use the identified font type 130 to determine whether the first discrepancy 128a is associated with the font type 130. For example, the font type 130 can be associated with one or more typographical characteristics 131 (e.g., font weight, font width, font contrast, X-height, etc.). In some cases, the computing system 106 can compare the identified font type 130 to a list of particular font types that can be difficult to recognize using the ACR algorithm 124. One or more respective typographical characteristics of the particular font types in the list of particular font types may impede character recognition of the ACR algorithm 124. For example, the font width of the particular font types may be less than a minimum font width associated with the ACR algorithm 124, such that the ACR algorithm 124 is unable to accurately separate individual characters of the particular font types. If the font type 130 matches a particular font type in the list of particular font types, the computing system 106 may attribute the first discrepancy 128a to being caused by a visual misinterpretation 102 related to the font type 130 of the interaction data 120a.

Based on the font type 130 corresponding to the interaction data 120a in the text fields 122, the machine-learning model 132 can determine suitable corrections to the interaction data 120a (e.g., by applying a rule set specific to the font type 130). If the computing system 106 identifies that the interaction data 120a includes a particular font type, the computing system 106 can attribute the first discrepancy 128a to the font type 130 of the interaction data 120a and determine the adjustment 134. In some cases, based on the font type 130, the computing system 106 can determine the adjustment 134 to modify the interaction data 120a.

In some cases, the computing system 106 can identify a difference between the interaction data 120a and the expected values 126 based on a comparison of the interaction data 120a and the expected values 126. The computing system 106 then can use the difference between the interaction data 120a and the expected values 126 to determine the adjustment 134 to the interaction data 120a. In some examples, the computing system 106 may recognize (e.g., using a rule set) that the difference between the interaction data 120a and the expected values 126 corresponds to a known character recognition error. Additionally or alternatively, the computing system 106 can use the machine-learning model 132 to determine the adjustment 134. In some examples in which the font type 130 involves a conjoined font, the machine-learning model 132 can be trained to determine the adjustment 134 with respect to segmenting the conjoined font to identify individual glyphs of the interaction data 120a.

As another example, if a specific discrepancy occurs relatively frequently for a particular font type, a specific rule set can be generated to address the specific discrepancy. For example, ‘I’ (i.e., a lowercase ‘L’) and ‘I’ (i.e., an uppercase ‘i’) in Arial font can appear visually similar with respect to a series of pixels being positioned in a vertically linear arrangement. In some cases, the specific rule set corresponding to Arial font may include applying an adjustment 134 of adjusting ‘I’ to ‘I’ if the ‘l’ is preceded and succeeded by a whitespace.

After determining the adjustment 134, the computing system 106 can apply the adjustment 134 to the interaction data 120a to generate updated interaction data 120b including the adjustment 134. The computing system 106 then can compare the updated interaction data 120b to the expected values 126 to determine whether the first discrepancy 128a is still present. If the first discrepancy 128a is absent between the updated interaction data 120b and the expected values 126, the computing system 106 can initiate the interaction 116 between the entities 118a-b. Once the computing system 106 initiates the interaction 116, the computing system 106 can transmit the interaction 116 to the interaction server 108 for processing. In some examples, processing the interaction 116 may involve performing a resource transfer between the first entity 118a and the second entity 118b that are involved in the interaction 116. Examples of resources transferred in the resource transfer can include computing resources (e.g., storage, RAM, threads, computing power, etc.), data, funds, or other suitable resources.

In some examples, the interaction data 120a and the expected values 126 can include a second discrepancy 128b that can be unrelated to the visual misinterpretation 102 of the image 112. In particular, the computing system 106 can determine that the second discrepancy 128b did not result from the visual misinterpretation 102 of the text fields 122 provided in the image 112. For example, the second discrepancy 128b may remain between the updated interaction data 120b and the expected values 126 after applying the adjustment 134 to the interaction data 120a. As another example, the machine-learning model 132 may determine that a dissimilarity (e.g., edit distance) between the interaction data 120a and the expected values 126 is above a predefined threshold. Accordingly, the machine-learning model 132 may generate an output indicating a relatively high likelihood of the second discrepancy 128b being unrelated to a visual misinterpretation 102 of the image 112.

After determining that the second discrepancy 128b did not result from the visual misinterpretation 102 of the image 112, the computing system 106 may flag the interaction 116 associated with the image 112. For instance, the computing system 106 may flag the interaction 116 as an unauthorized interaction 138. In some cases, the computing system 106 may transmit a notification to an entity 118 (e.g., first entity 118a) associated with the expected values 126 to request a response used to confirm whether the second discrepancy 128b is associated with an unauthorized interaction 138. The unauthorized interaction 138 can indicate that an identity associated with the entity 118 is unverifiable at least in part due to the second discrepancy 128b. Additionally or alternatively, the unauthorized interaction 138 may correspond to an amount of resources associated with the resource transfer of the interaction 116 being inconsistent. For example, a first amount of resources included in the interaction data 120a of the physical document 114 may be different (e.g., higher or lower) than a second amount of resources that is part of the expected values 126.

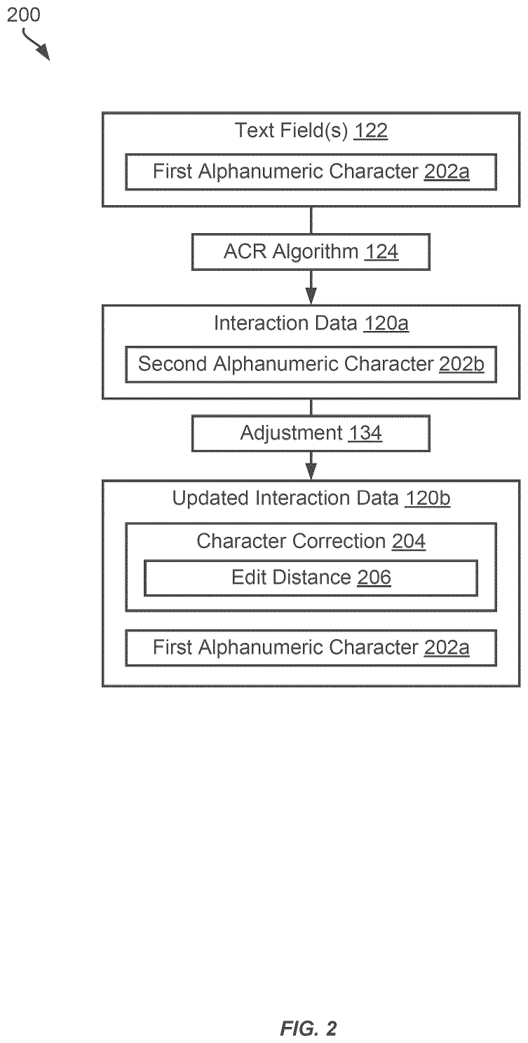

Although FIG. 1 is described with respect to the visual misinterpretation 102 being related to the font type 130 of the interaction data 120a, it will be appreciated that other causes of the visual misinterpretation 102 are possible. For instance, additional examples of the visual misinterpretation 102 are described below with respect to FIGS. 2-5. Additionally, while FIG. 1 depicts a specific arrangement of components, other examples can include more components, fewer components, different components, or a different arrangement of the components shown in FIG. 1. For instance, in other examples, the imaging device 110 may capture respective images of multiple physical documents that the computing system 106 can analyze using the ACR algorithm 124. Additionally, any component or combination of components depicted in FIG. 1 can be used to implement the process(es) described herein.

In FIGS. 2-5, various block diagrams of examples of sequences for automatically detecting and resolving a visual misinterpretation 102 of an image 112 arising from an ACR algorithm 124 are presented. For example, a machine-learning model 132 can be used to distinguish whether a discrepancy 128 between interaction data 120a of the image 112 and one or more expected values 126 is related to the visual misinterpretation 102 of the image 112. Aspects of FIGS. 2-5 are described below with reference to the components of FIG. 1.

FIG. 2 is a block diagram of a sequence 200 for automatically detecting and resolving a visual misinterpretation 102 arising from the ACR algorithm 124 misrecognizing a first alphanumeric character 202a as a second alphanumeric character 202b according to some aspects of the present disclosure. One or more text fields 122 provided in an image 112 received by a computing system 106 may include one or more alphanumeric characters 202 that can form interaction data 120a provided by a physical document 114 depicted in the image 112. The interaction data 120a may include structured or unstructured data, such as natural language text. The alphanumeric characters 202 of the text fields 122 can be grouped into at least one arrangement (e.g., sequences, graphemes, abbreviations, words, phrases, clauses, sentences, etc.). Additionally or alternatively, the text fields 122 can include special characters (e.g., symbols or punctuation). In some cases, the alphanumeric characters 202 and the special characters can be collectively referred to as glyphs.

As described above with respect to FIG. 1, the computing system 106 can execute the ACR algorithm 124 to extract the interaction data 120a from the image 112 of the physical document 114. Once the computing system 106 obtains the interaction data 120a of the physical document 114, the computing system 106 can compare the interaction data 120a to one or more expected values 126. In some examples, the computing system 106 may identify a discrepancy 128 between the interaction data 120a and the expected values 126. For example, the computing system 106 may obtain the interaction data 120a from the ACR algorithm 124 as a first text string. The computing system 106 then can compare the first text string to a second text string corresponding to the expected values 126. In some cases, the first text string may include the second alphanumeric character 202b in place of the first alphanumeric character 202a in the second text string. The discrepancy 128 can be a result of a visual misinterpretation 102 of the text fields 122 provided in the image 112.

In some examples, after identifying the discrepancy 128, the computing system 106 can use one or more rule sets to determine a reason for the discrepancy 128. Additionally, the computing system 106 can use the rule sets to determine an adjustment 134 to the interaction data 120a, such that the interaction data 120a matches the expected values 126. In some implementations, a rule set applied by the computing system 106 with respect to the first text string and the second text string may include a list of authorized corrections (e.g., modifying ‘O’ to ‘0’, ‘I’ to ‘I’, etc.). If the adjustment 134 is in the list of authorized corrections, the computing system 106 can determine that the reason for the discrepancy 128 corresponds to the ACR algorithm 124 misrecognizing the first alphanumeric character 202a. If the adjustment 134 to the interaction data 120a is outside of the list of authorized corrections, the computing system 106 may determine that the discrepancy 128 is unrelated to a visual misinterpretation 102 of the image 112. In cases in which the discrepancy 128 is determined to be unrelated to the visual misinterpretation 102 of the image, the computing system 106 may flag the interaction data 120a as being unverifiable.

Additionally or alternatively, the computing system 106 can use a machine-learning model 132 to determine the reason for the discrepancy 128. For example, the machine-learning model 132 can determine that the discrepancy 128 is caused by a misrecognition of the first alphanumeric character 202a in the text fields 122 as a second alphanumeric character 202b. As one such example, the expected value 126 may be ‘100’, whereas the interaction data 120a may include ‘1O0’. The machine-learning model 132 can determine that the ACR algorithm 124 has misrecognized the first alphanumeric character 202a of ‘0’ as the second alphanumeric character 202b of ‘O’. In some examples, the machine-learning model 132 may detect the misrecognition of the alphanumeric characters 202a-b based on a rule set. For example, the rule set may indicate that an alphabetic character (e.g., a letter) being preceded and succeeded by numeric characters is misrecognized.

In some cases, the rule set may be applicable depending on a field type of the text fields 122. For instance, if the physical document 114 is a standardized document, a respective location of the text fields 122 may be consistent across each physical document. Accordingly, the machine-learning model 132 can apply a respective rule set for each field type of the text fields 122 based on the respective location of the text fields 122. For example, if the field type of a specific text field corresponds to a numeric amount of resources being transferred in the interaction 116, the rule set may indicate to flag any alphabetic characters generated by the ACR algorithm 124 for the specific text field.

Once the computing system 106 determines that the discrepancy 128 in the interaction data 120a is caused by the misrecognition of the alphanumeric characters 202a-b, the computing system 106 can implement the adjustment 134 to the interaction data 120a. In some examples, the computing system 106 can leverage machine learning (e.g., the machine-learning model 132) to determine the adjustment 134 to the interaction data 120a. For example, the machine-learning model 132 can use edit distance 206 (e.g., Levenstein distance) associated with the interaction data 120a to determine a character correction 204 corresponding to the interaction data 120a. The edit distance 206 of the interaction data 120a can quantify (e.g., as a string metric) similarity or dissimilarity between the interaction data 120a and the expected values 126. In particular, the edit distance 206 can be associated with a minimum number of operations (e.g., substitutions, removals, deletions, insertions, transpositions, etc.) to transform one sequence (e.g., string) of characters into another sequence of characters. For example, the machine-learning model 132 can determine the edit distance 206 corresponding to potential modifications to the interaction data 120a, such that the interaction data 120a matches the expected values 126 after applying the potential modifications.

In some cases, the edit distance 206 can be categorized as a word edit distance, character edit distance, or a pixel edit distance. The word edit distance can indicate a number of words changed (e.g., added or removed) by the character correction 204. For example, a character correction 204 of ‘awhile’ to ‘a while’ can be quantified using a word edit distance of one, indicating that the number of words increased from one word to two words. The character edit distance can correspond to a number of letters changed as a result of applying the character correction 204 to the interaction data 120a. For example, a character correction 204 of ‘storm’ to ‘store’ can be quantified with a character edit distance of one, indicating that one character in the interaction data 120a was changed. The pixel edit distance can correspond to a number of pixels changed due to the character correction 204. For example, a character correction 204 of ‘while’ to ‘white’ can be quantified using a pixel edit distance of three to indicate that three pixels are changed to adjust ‘I’ to ‘t’. The three pixels can correspond visual differences between ‘I’ and ‘t’ (e.g., a crossbar of ‘t’ and a terminal of a vertical stroke of ‘t’)

Additionally or alternatively, the edit distance 206 can function as a metric to determine whether the discrepancy 128 of the interaction data 120a is caused by the visual misinterpretation 102 (e.g., the misrecognition of the alphanumeric characters 202a-b). In some examples, if the edit distance 206 is above a predefined threshold, the computing system 106 may determine that the discrepancy 128 has a relatively high likelihood of being associated with an unauthorized interaction 138. For example, a first edit distance between ‘ton’ and ‘ten’ may be lower than a second edit distance between ‘ten’ and ‘twenty’. Accordingly, if the interaction data 120a includes ‘ton’ and an expected value 126 includes ‘ten’, the machine-learning model 132 may determine that the first edit distance is below the predefined threshold. Accordingly, the machine-learning model 132 can classify the discrepancy 128 as a visual misinterpretation 102 of the image 112 associated with applying the ACR algorithm 124 to extract the interaction data 120a from the image 112. In contrast, if the interaction data 120a includes ‘ten’ and the expected value 126 includes ‘twenty’, the machine-learning model 132 may determine that the second edit distance is above the predefined threshold. Accordingly, the computing system 106 may flag the interaction 116 associated with the interaction data 120a as unauthorized or potentially unauthorized. If the computing system 106 flags the interaction 116 as potentially unauthorized, the computing system 106 may request a response from at least one of the entities 118a-b to confirm whether the interaction 116 is an unauthorized interaction 138.

In examples in which the discrepancy 128 is associated with the misrecognition of the alphanumeric characters 202a-b, the character correction 204 can involve adjusting the second alphanumeric character 202b in the interaction data 120a to the first alphanumeric character 202a. For example, the machine-learning model 132 can determine a character correction 204 to correct ‘ton’ to ‘ten by adjusting ‘o’ to ‘e’ based on the first edit distance. Once the machine-learning model 132 determines the character correction 204, the computing system 106 then can apply the character correction 204 to generate updated interaction data 120b that includes the first alphanumeric character 202a in place of the second alphanumeric character 202b.

In some cases, the character correction 204 can involve adjusting a numeric character to an alphabetic character. For example, the computing system 106 can apply a machine-learning model 132 that can be trained to identify that the discrepancy 128 was caused by misrecognizing a first alphanumeric character 202a of ‘E’ as a second alphanumeric character 202b of ‘8’. The machine-learning model 132 then can apply a character correction 204 of replacing ‘8’ with ‘E’ as the adjustment 134 to the interaction data 120a to correct the misrecognition. In some implementations, the machine-learning model 132 can extrapolate the adjustment 134 to other suitable instances in the current image 112 or later images. For example, an entity 118 associated with the interaction data 120a provided in the physical document 114 depicted in the image 112 may be identified using a name that starts with ‘E’ (e.g., Evelyn). Accordingly, the machine-learning model 132 can ensure that each instance of the name of the entity 118 in the interaction data 120a is correctly spelled with ‘E’ rather than ‘8’. As a result, the machine-learning model 132 of the computing system 106 can minimize discrepancies associated with an incorrect name of the entity 118. Additionally, using the machine-learning model 132 to extrapolate the adjustment 134 can facilitate data entry by increasing accuracy of text recognition while decreasing erroneous (e.g., false positive) identifications of unauthorized modifications.

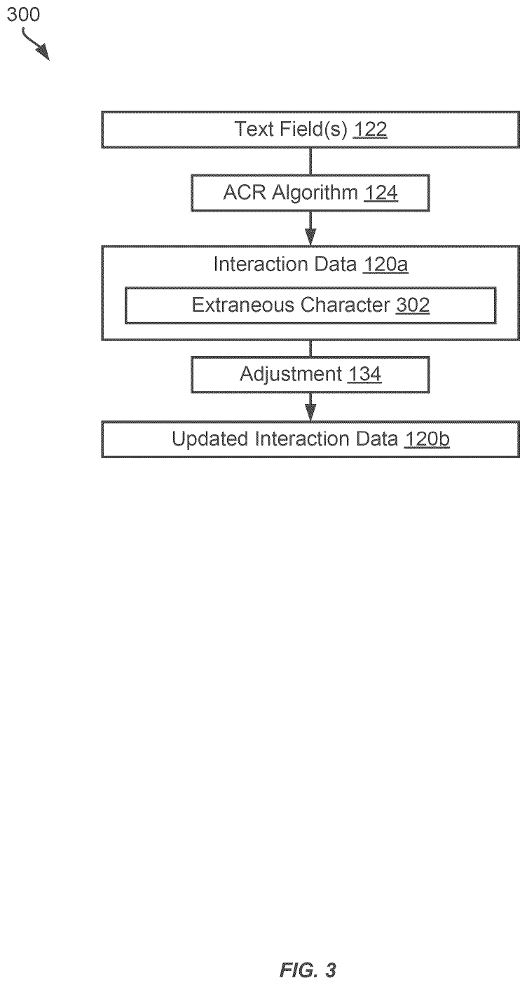

FIG. 3 is a block diagram of an example of a sequence 300 for automatically detecting and resolving a visual misinterpretation 102 arising from an ACR algorithm 124 adding an extraneous character 302 according to some aspects of the present disclosure. As described above with respect to FIG. 2, a computing system 106 may implement the ACR algorithm 124 to extract interaction data 120a from one or more text fields 122 presented in an image 112 of a physical document 114. The interaction data 120a can be used to initiate an interaction 116 (e.g., a resource transfer between two entities 118a-b). In some examples, the interaction data 120a obtained by the ACR algorithm 124 may include one or more errors due to the visual misinterpretation 102 of the ACR algorithm 124.

As depicted in FIG. 3, the interaction data 120a extracted by the ACR algorithm 124 can include a discrepancy 128 caused by an addition of the extraneous character 302. In some examples, the extraneous character 302 may be an alphanumeric character (e.g., a letter or a number). In other examples, the extraneous character 302 can be a special character (e.g., a symbol or punctuation). For example, the ACR algorithm 124 may interpret a stray mark in the image 112 as a hyphen. As another example, the extraneous character 302 can correspond to a diacritical mark (e.g., tilde, acute accent, macron, etc.) coupled to an alphabetic character.

In some cases, the computing system 106 may compare the interaction data 120a to one or more expected values 126 to identify the extraneous character 302 of the interaction data 120a. Additionally, the computing system 106 can use one or more rule sets to determine whether the extraneous character 302 corresponds to the visual misinterpretation 102 of the ACR algorithm 124. In some examples, the computing system 106 can apply a rule set that can define one or more problematic characters based on one or more additional characters adjacent to the extraneous character 302 in the interaction data 120a. For example, a comma or a period may be included as part of the problematic characters if the additional characters adjacent to the extraneous character 302 are numeric characters. In particular, the comma or the period can be considered problematic due to the problematic characters affecting place values or a magnitude of a numeric value represented by the numeric characters.

Using the rule set, the computing system 106 can determine whether the extraneous character 302 is included in the problematic characters. For instance, the computing system 106 can determine that the extraneous character 302 is absent from the problematic characters provided in the rule set in context of the additional characters adjacent to the extraneous character 302. The computing system 106 then can classify the discrepancy 128 as being caused by the visual misinterpretation 102 of the ACR algorithm 124.

Additionally or alternatively, the computing system 106 can use a machine-learning model 132 to identify the extraneous character 302. In some cases, detecting the discrepancy 128 can involve comparing the interaction data 120a to one or more expected values 126. If there is a mismatch between the interaction data 120a and the expected values 126, the machine-learning model 132 can identify the extraneous character 302 based on a difference between the interaction data 120a and the expected values 126. As an example, the interaction data 120a can include ‘one hundred and thirty-two’, and the expected values 126 can include ‘one hundred and thirty-two’. The machine-learning model 132 can determine that the discrepancy 128 between the interaction data 120a and the expected values 126 results from an extraneous character 302 of an extra hyphen between ‘thirty’ and ‘two’. Additionally, the machine-learning model 132 can confirm that the extraneous character 302 resulted from the visual misinterpretation 102 by identifying a stray mark positioned between ‘thirty’ and ‘two’ in the image 112.

After identifying the extraneous character 302, the machine-learning model 132 can generate an adjustment 134 to the interaction data 120a to address the discrepancy 128. In particular, the adjustment 134 can involve removing the extraneous character 302 from the interaction data 120a to generate updated interaction data 120b that excludes the extraneous character 302. For example, the updated interaction data 120b can lack the extra hyphen such that the updated interaction data 120b matches the expected values 126. Once the updated interaction data 120b is generated, the computing system 106 can initiate the interaction 116 using the updated interaction data 120b. In some examples, prior to initiating the interaction 116, the computing system 106 may compare the updated interaction data 120b to the expected values 126 to confirm that the updated interaction data 120b matches the expected values 126. In some such examples, if the computing system 106 detects another discrepancy in the updated interaction data 120b, the computing system 106 can use the machine-learning model 132 to determine another adjustment to the updated interaction data 120b.

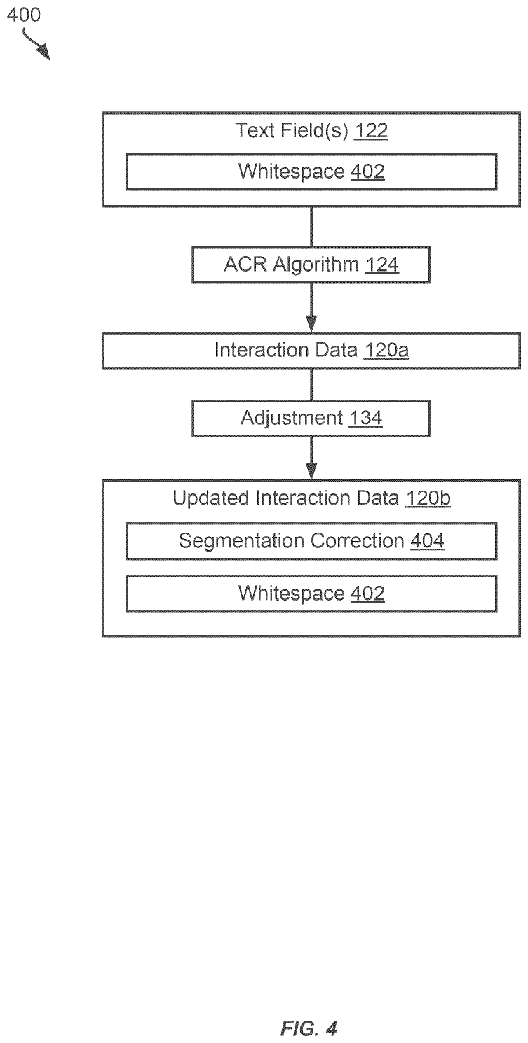

FIG. 4 is a block diagram of an example of a sequence 400 for automatically detecting and resolving a visual misinterpretation 102 arising from an ACR algorithm 124 omitting a whitespace 402 according to some aspects of the present disclosure. A computing system 106 can execute the ACR algorithm 124 to obtain interaction data 120a from an image 112 of a physical document 114 containing one or more text fields 122. When extracting the interaction data 120a from the text fields 122 of the image 112, the ACR algorithm 124 may be unsuccessful in detecting the whitespace 402, resulting in an omission of the whitespace 402. Incorrect segmentation of the ACR algorithm 124 with respect to separate sequences or strings in a line of text can cause the omission of the whitespace 402. In some examples, the omitted whitespace 402 can correspond to a whitespace character that can function as a separator between words or sentences in text. In additional or alternative examples, the omitted whitespace 402 may correspond to line spacing or paragraph spacing.

The lack of the whitespace 402 may cause a discrepancy 128 between the interaction data 120a and one or more expected values 126. The discrepancy 128 can prevent the computing system 106 from initiating an interaction 116 associated with the physical document 114. As described above (e.g., with respect to FIG. 3), the computing system 106 can identify the discrepancy 128 between the interaction data 120a and the expected values 126 by comparing the interaction data 120a and the expected values 126. Once the discrepancy 128 is identified, the computing system 106 can apply one or more rule sets to determine whether the discrepancy 128 is associated with the ACR algorithm 124 omitting the whitespace 402 in the interaction data 120a.

Additionally or alternatively, the computing system 106 can execute a machine-learning model 132 to determine an adjustment 134 to the interaction data 120a to replace the whitespace 402 that was omitted in the interaction data 120a. Although FIG. 4 is described with respect to the visual misinterpretation 102 corresponding to omitting the whitespace 402, it will be appreciated that the visual misinterpretation 102 can involve adding an extraneous whitespace. The extraneous whitespace can be corrected similar to the visual misinterpretation 102 describe above with respect to adding the extraneous character 302 of FIG. 3.

In some cases, the computing system 106 can detect that the whitespace 402 was omitted by determining a difference between the interaction data 120a and the expected values 126. For example, if the interaction data includes ‘RecipientA’ and the expected values 126 include ‘Recipient A’, the computing system 106 can determine that a whitespace 402 between ‘Recipient’ and ‘A’ was omitted. Although this example is described with respect to a single whitespace, it will be appreciated that the whitespace 402 omitted may correspond to more than one white space or a relatively large whitespace (e.g., a line break). In some examples, the computing system 106 may use machine learning to compare the interaction data 120a and the expected values 126. For example, a machine-learning model 132 of the computing system 106 can compare each character in the interaction data 120a and the expected values 126 to determine that a whitespace 402 is missing from the interaction data 120a. The machine-learning model 132 then can determine a segmentation correction 404 to address the discrepancy 128 by adding in the whitespace 402. In some cases, the segmentation correction 404 can adjust a position at which the ACR algorithm 124 segments the interaction data 120a, thereby adding in the whitespace 402 where the whitespace 402 was previously omitted.

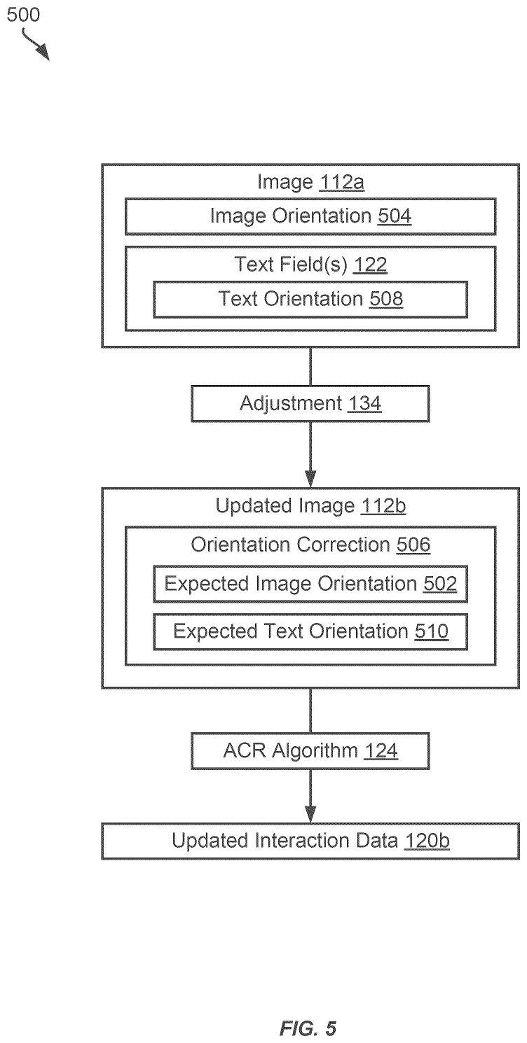

FIG. 5 is a block diagram of an example of a sequence 500 for automatically detecting and resolving a visual misinterpretation 102 arising from an image 112 being askew relative to an expected image orientation 502 according to some aspects of the present disclosure. As described above with respect to FIG. 1, a computing system 106 can use an ACR algorithm 124 to extract interaction data 120a from an image 112a of a physical document 114. The ACR algorithm 124 can visually analyze one or more text fields 122 of the physical document 114 provided in the image 112a to extract the interaction data 120a. If an image orientation 504 of the image 112a does not match the expected image orientation 502, the ACR algorithm 124 may have difficulty obtaining the interaction data 120a from the text fields 122 provided in the image 112a. In some cases, using the ACR algorithm 124 to analyze the image 112a that is askew relative to the expected image orientation 502 can result in a discrepancy between interaction data 120a obtained by the ACR algorithm 124 and expected values 126.

In some examples, the computing system 106 can use machine learning (e.g., using a machine-learning model 132) or other suitable techniques to determine an orientation correction 506 to apply to the image 112a prior to executing the ACR algorithm 124. The orientation correction 506 can adjust the image orientation 504 such that the image 112a is more closely aligned with the expected image orientation 502. For example, the computing system 106 can apply the orientation correction 506 as a pre-processing technique to prepare the image 112a for character recognition analysis. Other examples of pre-processing techniques that the computing system 106 can apply to the image 112a prior to implementing the ACR algorithm 124 can include noise removal, image smoothing, thinning, or skeletonization.

Additionally or alternatively, the computing system 106 can apply the orientation correction 506 after detecting the discrepancy 128 between the interaction data 120a and the expected values 126. The orientation correction 506 can function as an adjustment 134 to the image 112a to correct an image orientation 504 of the image 112a. In some implementations, adjusting the image orientation 504 can modify a text orientation 508 corresponding to the text fields 122 to match an expected text orientation 510. As a result of the text orientation 508 matching the expected text orientation 510, the ACR algorithm 124 can obtain the interaction data 120a from the text fields 122.

In some examples, the machine-learning model 132 of the computing system 106 can determine the orientation correction 506 at least in part based on whether to rotate the image 112a clockwise or counterclockwise. Additionally, if the machine-learning model 132 determines that the orientation correction 506 involves rotating the image 112a, the machine-learning model 132 can determine a degree of rotation to rotate the image 112a. For example, the machine-learning model 132 may determine the orientation correction 506 by comparing the current image orientation 504 of the image 112a to the expected image orientation 502. In some implementations, the machine-learning model 132 may identify one or more edges or corners of the physical document 114 provided in the image 112a to determine the current image orientation 504 of the image 112a. For instance, if the physical document 114 has four corners, two corners on a right side of the physical document 114 being positioned higher than two other corners on a left side of the physical document 114 can indicate that the image 112a is tilted counterclockwise. The machine-learning model 132 then can determine the orientation correction 506 to include tilting the image 112a clockwise such that the four corners of the physical document 114 in the image 112a are in alignment with the expected image orientation 502. In some cases, the four corners of the physical document 114 being in alignment with the expected image orientation 502 can correspond to one or more subsets of the four corners being aligned on a same horizontal axis or vertical axis.

In other implementations, the computing system 106 can analyze pixels of the image 112a that correspond to the text fields 122 to determine skewness of the image 112a. For example, the computing system 106 may rotate the image 112a using a set of angles within a predefined range. At each angle within the set of angles, the computing system 106 can analyze pixels of the image 112a to determine a total number of pixels in each row of the image 112a. The computing system 106 then can generate a plot of an image row number versus the total number of pixels in a corresponding row. The plot can include one or more peaks that the computing system 106 can use to determine a maximum difference (e.g., variance) between the peaks. An angle corresponding to the maximum difference between the peaks can represent a skew angle associated with the skewness of the image orientation 504 of the image 112a. Once the computing system 106 determines the skew angle, the computing system 106 can determine the orientation correction 506 to correct the skewness of the image orientation 504 by rotating the image 112a using a rotation angle. The rotation angle can be equal in magnitude to the skew angle but in an opposite direction of the skew angle.

Additionally or alternatively, the machine-learning model 132 can determine the orientation correction 506 with respect to the text orientation 508 of the text fields 122. For example, an expected text orientation 510 of the text fields 122 may be aligned with a horizontal axis of the image 112a such that the text fields 122 are parallel to the horizontal axis. If the text orientation 508 of the text fields 122 is misaligned with the horizontal axis, the machine-learning model 132 can determine the orientation correction 506 to the image 112a to update the text orientation 508 to match the horizontal axis.

Once the computing system 106 applies the adjustment 134 to the image 112a to update a position (e.g., the image orientation 504) of the image 112a, the computing system 106 can generate an updated image 112b having the expected image orientation 502. The computing system 106 then can apply the ACR algorithm 124 to the updated image 112b to obtain updated interaction data 120b. If the updated interaction data 120b matches one or more expected values 126, the computing system 106 can initiate an interaction 116 associated with the physical document 114 provided in the images 112a-b using the updated interaction data 120b.

Alternatively, in some examples, the computing system 106 may identify a discrepancy 128 in the updated interaction data 120b after applying the orientation correction 506 to the image 112a. In such examples, the discrepancy 128 can be caused by another visual misinterpretation (e.g., the visual misinterpretations described above with respect to FIGS. 2-4). As another example, the discrepancy 128 may result from an unauthorized interaction 138 associated with the updated interaction data 120b. For instance, the physical document 114 or the image 112a may have been falsified (e.g., altered, forged, etc.) prior to being received by the computing system 106.

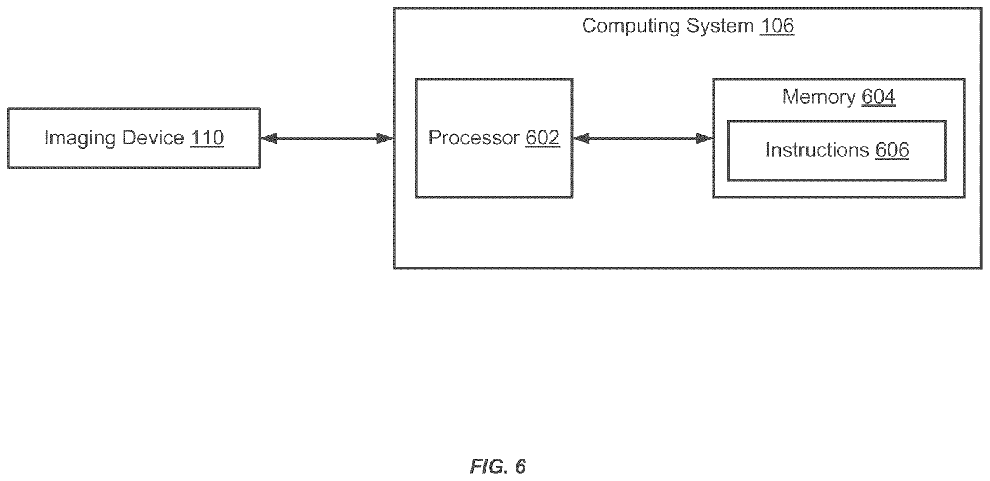

FIG. 6 is a block diagram of an example of a computing system 106 usable for automatically detecting and resolving a visual misinterpretation 102 of a scanned image 112 according to some aspects of the present disclosure. The computing system 106 can include a processing device 602 communicatively coupled to a memory device 604. The computing system 106 may be configured to perform any of the techniques described above.

The processing device 602 can include one processing device or multiple processing devices. The processing device 602 can be referred to as a processor. Non-limiting examples of the processing device 602 include a Field-Programmable Gate Array (FPGA), an application-specific integrated circuit (ASIC), and a microprocessor. The processing device 602 can execute instructions 606 stored in the memory device 604 to perform operations. Examples of such operations can include any of the operations described above with respect to determining adjustments to address the visual misinterpretation 102 of an ACR algorithm 124. In some examples, the instructions 606 can include processor-specific instructions generated by a compiler or an interpreter from code written in any suitable computer-programming language, such as C, C++, C#, Java, Python, or any combination of these.

The memory device 604 can include one memory device or multiple memory devices. The memory device 604 can be non-volatile and may include any type of memory device that retains stored information when powered off. Non-limiting examples of the memory device 604 include electrically erasable and programmable read-only memory (EEPROM), flash memory, or any other type of non-volatile memory. At least some of the memory device 604 includes a non-transitory computer-readable medium from which the processing device 602 can read instructions 606. A computer-readable medium can include electronic, optical, magnetic, or other storage devices capable of providing the processing device 602 with the instructions 606 or other program code. Non-limiting examples of a computer-readable medium include magnetic disk(s), memory chip(s), ROM, random-access memory (RAM), an ASIC, a configured processor, and optical storage.

The computing system 106 additionally may include one or more input/output (I/O) components. For example, the computing system 106 can include an imaging device 110 communicatively coupled to the computing system 106. Additionally or alternatively, the computing system 106 can include other I/O components that are not shown for simplicity. Examples of such input components can include a mouse, a keyboard, a trackball, a touch pad, and a touch-screen display. Examples of such output components can include a visual display or an audio display. Examples of the visual display can include a liquid crystal display (LCD), a light-emitting diode (LED) display, or the touch-screen display. An example of the audio display can include speakers. In some cases, the I/O components can be integrated into a single structure with the components of the computing system 106. For example, the I/O components may be positioned within a single housing (e.g., the computing system 106 of FIG. 1) with the components of the computing system 106. In other examples, the I/O components can be distributed (e.g., in separate housings) and in electrical communication with each other and the computing system 106. For example, the imaging device 110 may be part of a computing device that is separate from the computing system 106.

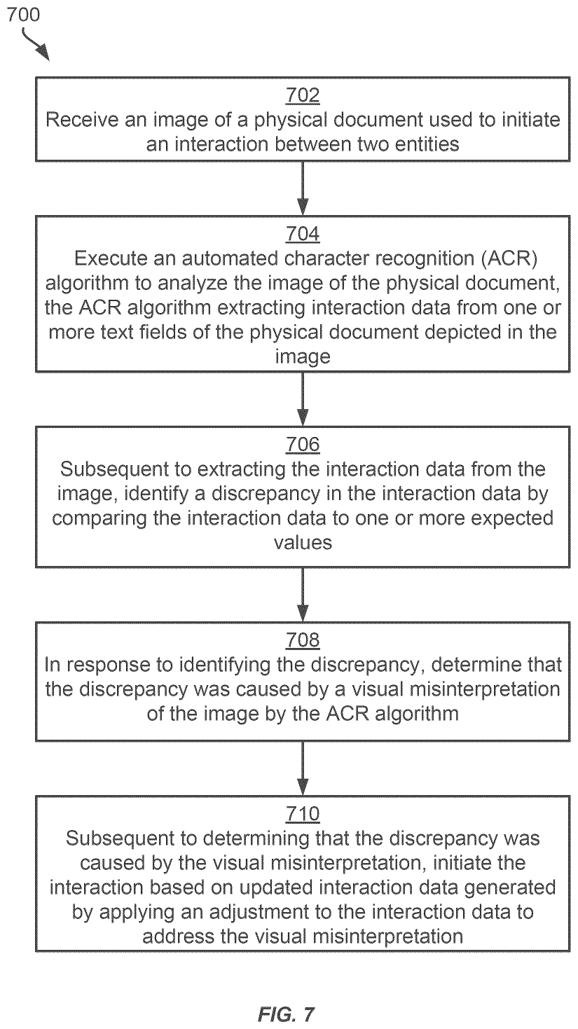

FIG. 7 is a flowchart of a process 700 for using a machine learning system to automatically detect and resolve a visual misinterpretation 102 of a scanned image 112 according to some aspects of the present disclosure. A machine-learning model 132 can be implemented as part of the machine learning system. In some examples, the processing device 602 can perform one or more of the steps shown in FIG. 7. In other examples, the processing device 602 can implement more steps, fewer steps, different steps, or a different order of the steps depicted in FIG. 7. The steps of FIG. 7 are described below with reference to components discussed above in FIGS. 1 and 6.

In block 702, a processing device 602 receives the image 112 of a physical document 114 used to initiate an interaction 116 between two entities 118a-b. In some examples, the processing device 602 may receive the image 112 from an imaging device 110, which may scan the physical document 114 to generate the image 112 of the physical document 114. Prior to initiating the interaction 116 between the entities 118a-b, the processing device 602 can extract the interaction data 120a from the image 112 to compare with one or more expected values 126 to validate the interaction 116. In some cases, prior to extracting the interaction data 120a, the processing device 602 can apply one or more pre-processing techniques (e.g., noise removal, skew correction, etc.) to the image 112 to facilitate the extraction of the interaction data 120a.

In block 704, the processing device 602 executes an automated character recognition (ACR) algorithm 124 to analyze the image 112 of the physical document 114 to obtain the interaction data 120a from the image 112. The ACR algorithm 124 can be used to extract the interaction data 120a from one or more text fields 122 of the physical document 114 depicted in the image 112. In some cases, machine learning can be implemented with the ACR algorithm 124 to enable improvements to an accuracy of the ACR algorithm 124 over time. For example, a neural network can be used to improve the ACR algorithm 124 over time using updated training data to augment a recognition database of the ACR algorithm 124. The updated training data can be updated as the ACR algorithm 124 is used over time to convert detected text in images to machine-readable text.

In block 706, subsequent to extracting the interaction data 120a from the image 112, the processing device 602 identifies a discrepancy 128 in the interaction data 120a by comparing the interaction data 120a to the expected values 126. In some cases, the processing device 602 may obtain the expected values 126 from an interaction server 108 that can be used to process the interaction 116 using the interaction data 120a. As an example, the interaction data 120a in the text fields 122 of the physical document 114 can be inputted by a first entity 118a. The physical document 114 can be transmitted by the first entity 118a to a second entity 118b such that the second entity 118b can use the physical document 114 to initiate the interaction 116. The expected values 126 can be provided by the first entity 118a to the interaction server 108. Accordingly, the expected values 126 can be used to validate the interaction 116 by ensuring that the interaction data 120a are unchanged when compared to the expected values 126.

If there is a mismatch (e.g., the discrepancy 128) between the expected values 126 and the interaction data 120a, the processing device 602 can analyze the discrepancy 128 to determine whether the interaction 116 is an unauthorized interaction 138. For example, the processing device 602 can implement one or more rule sets that can each include a respective list of acceptable discrepancies. If the discrepancy 128 is unrelated to acceptable discrepancies provided in the lists of acceptable discrepancies, the processing device 602 may determine that the interaction 116 is an unauthorized interaction 138.

In block 708, in response to identifying the discrepancy 128 in the interaction data 120a, the processing device 602 determines that the discrepancy 128 was caused by a visual misinterpretation 102 of the image 112 by the ACR algorithm 124. In some examples, the processing device 602 can provide input to the machine-learning model 132 to determine whether the discrepancy 128 was caused by the visual misinterpretation 102 of the image 112. Examples of the input to the machine-learning model 132 can include interaction data 120a, the expected values 126, or a combination of these. Using the input received from the processing device 602, the machine-learning model 132 can generate an output indicating whether the discrepancy 128 was caused by the visual misinterpretation 102 of the image 112.

In some cases, the processing device 602 can use the machine-learning model 132 configured to use edit distance 206 to determine an adjustment 134 to the interaction data 120a to correct the visual misinterpretation 102. Examples of the edit distance 206 associated with modifying the interaction data 120a can include word edit distance, character edit distance, pixel edit distance, or a combination of these. The machine-learning model 132 can be trained to account for the edit distance 206 to determine an adjustment 134 to the interaction data 120a such that the interaction data 120a matches the expected values 126. For example, the adjustment 134 determined by the machine-learning model 132 may have a minimal edit distance compared to other possible adjustments.

Additionally or alternatively, the machine-learning model 132 can be trained to account for context of the interaction data 120a. For instance, the processing device 602 can use natural language processing to train the machine-learning model 132 to develop context of the interaction data 120a. In some examples, the adjustment 134 can be determined by the machine-learning model 132 at least in part based on a usage frequency of a word or a sequence with respect to adjacent words or sequences. For example, if the interaction data 120a includes ‘mine hundred’, the machine-learning model 132 can use the context of ‘hundred’ to correct ‘mine’ to ‘nine’. In this example, ‘nine’ can be used or appear more frequently with ‘hundred’ compared to ‘mine’ such that a first usage frequency of ‘nine’ can be higher than a second usage frequency of ‘mine’ with respect to ‘hundred’.

In some examples, the machine-learning model 132 can use the edit distance 206 associated with the adjustment 134 to analyze the discrepancy 128 with respect to whether the discrepancy 128 is associated with unauthorized modifications. For example, the machine-learning model 132 can determine a relatively low likelihood or a relatively high likelihood of the discrepancy 128 being associated with an unauthorized modification to the image 112 or the physical document 114. A predefined threshold associated with the edit distance 206 can be set to delineate whether the discrepancy 128 is more likely due to the visual misinterpretation 102 of the image 112 or more likely due to the unauthorized modification. For example, if the edit distance 206 associated with the adjustment 134 of the interaction data 120a is below the predefined threshold, the discrepancy 128 may be more likely due to the visual misinterpretation 102 of the image.

In some examples, the processing device 602 may instead determine that the discrepancy 128 is unrelated to the visual misinterpretation 102 of the image 112. For example, if the edit distance 206 associated with the adjustment 134 to the interaction data 120a is above the predefined threshold, the discrepancy 128 may result from one or more unauthorized modifications to the image 112 or the physical document 114. In some implementation, if the interaction 116 is associated with a financial transaction, the unauthorized modifications to the image 112 or the physical document 114 may be associated with fraud (e.g., identity theft, synthetic identity, forgery, etc.). Accordingly, the processing device 602 can flag the interaction 116 associated with the interaction data 120a obtained using the image 112 as an unauthorized interaction 138. In some cases, after determining that the interaction 116 is associated with unauthorized modifications, the processing device 602 may prevent the interaction 116 from being initiated or processed.

In block 710, subsequent to determining that the discrepancy 128 was caused by the visual misinterpretation, the processing device 602 initiates the interaction 116 based on updated interaction data 120b associated with the physical document 114. The processing device 602 can generate the updated interaction data 120b by applying the adjustment 134 to the interaction data 120a to address the visual misinterpretation 102. For example, if the visual misinterpretation 102 is associated with font size of the text fields 122, the processing device 602 can increase or decrease the font size of the text fields 122 as the adjustment 134 to address the visual misinterpretation 102. In some cases, once the updated interaction data 120b is generated, the processing device 602 can transmit an interaction request including the updated interaction data 120b to the interaction server 108 to process the interaction 116. The updated interaction data 120b can be used by the interaction server 108 to transfer an amount of resources detailed in the updated interaction data 120b from the first entity 118a to the second entity 118b.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations including:
executing a machine-learning model on interaction data extracted from an image of a physical document, wherein the physical document is for initiating an interaction between two entities, the interaction data comprising a discrepancy such that the interaction data is different from one or more expected values, wherein the machine-learning model is configured to determine whether the discrepancy was caused by a visual misinterpretation of the image when an automated character recognition algorithm was applied to the image to extract the interaction data; and
in response to determining that the discrepancy was caused by the visual misinterpretation of the image, applying, by the machine-learning model, an adjustment to the interaction data to resolve the visual misinterpretation, wherein applying the adjustment generates updated interaction data usable to initiate the interaction.

2. The system of claim 1, wherein the discrepancy is a first discrepancy, and wherein the operations further comprise, subsequent to receiving the interaction data:
determining, by the machine-learning model, that a second discrepancy of the interaction data did not result from the visual misinterpretation of the image; and
in response to determining that the second discrepancy did not result from the visual misinterpretation of the image, flagging the interaction associated with the image as an unauthorized interaction.

3. The system of claim 1, wherein the operations further comprise, subsequent to receiving the interaction data:
determining, using the machine-learning model, that the visual misinterpretation involves a misrecognition of a first alphanumeric character as a second alphanumeric character, the misrecognition occurring in one or more text fields of the physical document depicted in the image; and
in response to determining that the visual misinterpretation involves the misrecognition, applying a character correction to replace the second alphanumeric character with the first alphanumeric character as the adjustment to address the visual misinterpretation, wherein the machine-learning model is configured to determine the character correction at least in part by comparing the interaction data to the one or more expected values.

4. The system of claim 1, wherein the operations further comprise, subsequent to receiving the interaction data:
determining, using the machine-learning model, that the visual misinterpretation involves an addition of an extraneous character to the interaction data when extracting the interaction data from one or more text fields of the physical document depicted in the image; and
in response to determining that the visual misinterpretation involves the addition of the extraneous character, removing the extraneous character from the interaction data as the adjustment to generate the updated interaction data.

5. The system of claim 1, wherein the operations further comprise, subsequent to receiving the interaction data:
identifying, using the machine-learning model, a font type associated with the interaction data, wherein the machine-learning model is trained to identify the font type by determining one or more typographical characteristics of the interaction data provided in one or more text fields of the physical document depicted in the image;
determining, using the machine-learning model, that the visual misinterpretation is associated with the font type; and
applying the adjustment to the interaction data to generate the updated interaction data, wherein the adjustment is determined by the machine-learning model based on the font type.

6. The system of claim 1, wherein the operations further comprise, subsequent to receiving the interaction data:
determining, using the machine-learning model, that the visual misinterpretation involves an omission of a whitespace when extracting the interaction data from one or more text fields of the physical document depicted in the image; and
in response to determining that the visual misinterpretation involves the omission of the whitespace, applying a segmentation correction as the adjustment to the interaction data to generate the updated interaction data, wherein the segmentation correction involves adding in the whitespace associated with the interaction data.

7. The system of claim 1, wherein the operations comprise, subsequent to receiving the interaction data:
determining, using the machine-learning model, that the visual misinterpretation was caused by the image of the physical document being askew relative to an expected image orientation of the image, wherein the machine-learning model is configured to compare an image orientation of the image to the expected image orientation; and
in response to determining that the visual misinterpretation was caused by the image of the physical document being askew, applying an orientation correction to the image as the adjustment to generate an updated image, wherein the orientation correction is configured to rotate the image such that the image is more closely aligned with the expected image orientation.

8. A method comprising:
executing a machine-learning model on interaction data extracted from an image of a physical document, wherein the physical document is for initiating an interaction between two entities, the interaction data comprising a discrepancy such that the interaction data is different from one or more expected values, wherein the machine-learning model determines whether the discrepancy was caused by a visual misinterpretation of the image when an automated character recognition algorithm was applied to the image to extract the interaction data; and
in response to determining that the discrepancy was caused by the visual misinterpretation of the image, applying, by the machine-learning model, an adjustment to the interaction data to resolve the visual misinterpretation, wherein applying the adjustment generates updated interaction data usable to initiate the interaction.

9. The method of claim 8, wherein the discrepancy is a first discrepancy, and wherein the method further comprises, subsequent to receiving the interaction data:
determining, by the machine-learning model, that a second discrepancy of the interaction data did not result from the visual misinterpretation of the image; and
in response to determining that the second discrepancy did not result from the visual misinterpretation of the image, flagging the interaction associated with the image as an unauthorized interaction.

10. The method of claim 8, further comprising, subsequent to receiving the interaction data:
determining, using the machine-learning model, that the visual misinterpretation involves a misrecognition of a first alphanumeric character as a second alphanumeric character, the misrecognition occurring in one or more text fields of the physical document depicted in the image; and
in response to determining that the visual misinterpretation involves the misrecognition, applying a character correction to replace the second alphanumeric character with the first alphanumeric character as the adjustment to address the visual misinterpretation, wherein the machine-learning model is configured to determine the character correction at least in part by comparing the interaction data to the one or more expected values.

11. The method of claim 8, further comprising, subsequent to receiving the interaction data:
determining, using the machine-learning model, that the visual misinterpretation involves an addition of an extraneous character to the interaction data when extracting the interaction data from one or more text fields of the physical document depicted in the image; and
in response to determining that the visual misinterpretation involves the addition of the extraneous character, removing the extraneous character from the interaction data as the adjustment to generate the updated interaction data.

12. The method of claim 8, further comprising, subsequent to receiving the interaction data:
identifying, using the machine-learning model, a font type associated with the interaction data, wherein the machine-learning model is trained to identify the font type by determining one or more typographical characteristics of the interaction data provided in one or more text fields of the physical document depicted in the image;
determining, using the machine-learning model, that the visual misinterpretation is associated with the font type; and
applying the adjustment to the interaction data to generate the updated interaction data, wherein the adjustment is determined by the machine-learning model based on the font type.

13. The method of claim 8, further comprising, subsequent to receiving the interaction data:
determining, using the machine-learning model, that the visual misinterpretation involves an omission of a whitespace when extracting the interaction data from one or more text fields of the physical document depicted in the image; and
in response to determining that the visual misinterpretation involves the omission of the whitespace, applying a segmentation correction as the adjustment to the interaction data to generate the updated interaction data, wherein the segmentation correction involves adding in the whitespace associated with the interaction data.

14. The method of claim 8, further comprising, subsequent to receiving the interaction data:
determining, using the machine-learning model, that the visual misinterpretation was caused by the image of the physical document being askew relative to an expected image orientation of the image, wherein the machine-learning model is configured to compare an image orientation of the image to the expected image orientation; and
in response to determining that the visual misinterpretation was caused by the image of the physical document being askew, applying an orientation correction to the image as the adjustment to generate an updated image, wherein the orientation correction is configured to rotate the image such that the image is more closely aligned with the expected image orientation.

15. A non-transitory computer-readable medium comprising program code executable by a processing device for causing the processing device to perform operations comprising:
executing a machine-learning model on interaction data extracted from an image of a physical document, wherein the physical document is for initiating an interaction between two entities, the interaction data comprising a discrepancy such that the interaction data is different from one or more expected values, wherein the machine-learning model is configured to determine whether the discrepancy was caused by a visual misinterpretation of the image when an automated character recognition algorithm was applied to extract the interaction data from the image; and
in response to determining that the discrepancy was caused by the visual misinterpretation of the image, applying, by the machine-learning model, an adjustment to the interaction data to resolve the visual misinterpretation, wherein applying the adjustment generates updated interaction data usable to initiate the interaction.

16. The non-transitory computer-readable medium of claim 15, wherein the discrepancy is a first discrepancy, and wherein the operations further comprise, subsequent to receiving the interaction data:
determining, by the machine-learning model, that a second discrepancy of the interaction data did not result from the visual misinterpretation of the image; and
in response to determining that the second discrepancy did not result from the visual misinterpretation of the image, flagging the interaction associated with the image as an unauthorized interaction.

17. The non-transitory computer-readable medium of claim 15, wherein the operations further comprise, subsequent to receiving the interaction data:
determining, using the machine-learning model, that the visual misinterpretation involves a misrecognition of a first alphanumeric character as a second alphanumeric character, the misrecognition occurring in one or more text fields of the physical document depicted in the image; and
in response to determining that the visual misinterpretation involves the misrecognition, applying a character correction to replace the second alphanumeric character with the first alphanumeric character as the adjustment to address the visual misinterpretation, wherein the machine-learning model is configured to determine the character correction at least in part by comparing the interaction data to the one or more expected values.

18. The non-transitory computer-readable medium of claim 15, wherein the operations further comprise, subsequent to receiving the interaction data:
determining, using the machine-learning model, that the visual misinterpretation involves an addition of an extraneous character to the interaction data when extracting the interaction data from one or more text fields of the physical document depicted in the image; and
in response to determining that the visual misinterpretation involves the addition of the extraneous character, removing the extraneous character from the interaction data as the adjustment to generate the updated interaction data.

19. The non-transitory computer-readable medium of claim 15, wherein the operations further comprise, subsequent to receiving the interaction data:
identifying, using the machine-learning model, a font type associated with the interaction data, wherein the machine-learning model is trained to identify the font type by determining one or more typographical characteristics of the interaction data provided in one or more text fields of the physical document depicted in the image;
determining, using the machine-learning model, that the visual misinterpretation is associated with the font type; and
applying the adjustment to the interaction data to generate the updated interaction data, wherein the adjustment is determined by the machine-learning model based on the font type.

20. The non-transitory computer-readable medium of claim 15, wherein the operations further comprise, subsequent to receiving the interaction data:
determining, using the machine-learning model, that the visual misinterpretation involves an omission of a whitespace when extracting the interaction data from one or more text fields of the physical document depicted in the image; and
in response to determining that the visual misinterpretation involves the omission of the whitespace, applying a segmentation correction as the adjustment to the interaction data to generate the updated interaction data, wherein the segmentation correction involves adding in the whitespace associated with the interaction data.
